(19) United States
(12) Patent Application Publication
(10) Pub. No.: US 2023/0298023 A1
(43) Pub. Date: Sep. 21, 2023

(54) ELECTRIC ENERGY AND CARBON EMISSION MEASUREMENT ACCOUNTING METHOD BASED ON DIGITAL PAYMENT WALLET AND BLOCKCHAIN

(71) Applicant: Xizhong ZHOU, Chaoyang District Beijing (CN)

(72) Inventor: Xizhong ZHOU, Chaoyang District Beijing (CN)

(21) Appl. No.: 18/021,503

(22) PCT Filed: Mar. 3, 2022
(86) PCT No.: PCT/CN2022/078971

§ 371 Date: Feb. 15, 2023

(30) Foreign Application Priority Data
Jan. 29, 2022 (CN) 202210112586.5

(51) Int. Cl. G06Q 20/40; G06Q 20/36; G06Q 20/38

(52) U.S. Cl. CPC G06Q 20/4014; G06Q 20/36; G06Q 20/389

(57) ABSTRACT

Disclosed in the present application is an electric energy and carbon emission measurement accounting method based on a digital payment wallet and a blockchain. Automatic measurements on power generation capacity (electricity supply data) and power consumption (electricity consumption data) of a regional power distribution network are performed by the blockchain in combination with the digital payment wallet. Problems about establishment, authentication, and right confirmation of a digital identity of a smart meter are resolved. An accounting value of carbon emission from energy consumption of an intra-regional energy network is generated by subtracting an electric energy consumption value from an intra-regional electric energy supply value, and intra-regional carbon emission is measured based on the accounting value of the carbon emission from the energy consumption of the intra-regional energy network. A problem that the carbon emission cannot be accurately traced back by an amount of consumed electric energy is resolved.

The present application claims priority to Chinese Patent Application No. 202210112586.5, filed with the Chinese Patent Office on Jan. 29, 2022 and entitled “ELECTRIC ENERGY AND CARBON EMISSION MEASUREMENT ACCOUNTING METHOD BASED ON DIGITAL PAYMENT WALLET AND BLOCKCHAIN”, which is incorporated herein by reference in its entirety.

### FIELD OF THE INVENTION

The present application relates to the technical fields of new energy sources, energy transaction accountings, and transaction accountings of carbon emission from energy consumption, and in particular, to an electric energy and carbon emission measurement accounting method based on a digital payment wallet and a blockchain.

### BACKGROUND OF THE INVENTION

Within a range of a region, an amount of consumed electric energy is related to intra-regional carbon emission. In order to acquire the intra-regional carbon emission, measurements on an electric energy supply source and load-consumed energy for the region needs to be done.

At present, a method for performing measurements on carbon emission is to trace back the carbon emission by an amount of consumed electric energy. However, in a process of performing measurements on the electric energy, a plurality of participants may be involved, such as, multi supply sources, multi suppliers, and multi energy consumers for the electric energy. Different participants may generate different electric energy values, and different energy consumers may use different electric energy. In this way, various types of electric energy values are involved in the process of tracing back the carbon emission by the electric energy, and thus a calculation process is very troublesome and easily goes wrong, resulting in inaccurate metering of the carbon emission. Therefore, it is impossible to accurately trace back the carbon emission by the amount of the consumed electric energy at present.

### SUMMARY OF THE INVENTION

The present application provides an electric energy and carbon emission measurement accounting method based on a digital payment wallet and a blockchain, to resolve a problem that carbon emission cannot be accurately traced back by an amount of consumed electric energy in current measurement accounting processes of electric energy and carbon emission from energy consumption.

An electric energy and carbon emission measurement accounting method based on a digital payment wallet and a blockchain is provided, including:

establishing digital identities of intra-regional smart meters based on the blockchain, where each of the smart meters corresponds to one of the digital identities; performing authentication and right confirmation on the digital identity based on a smart contract; performing association of a plurality of the digital identities, on which authentication and right confirmation are performed, with electric energy supply sources and suppliers, and energy consumers of the respective ones of the smart meter by the authentication of the digital identity based on the blockchain; identifying an attribute and data of the smart meter to generate electricity consumption record data including electricity supply data of the electric energy supply source and the supplier and electricity consumption data of the energy consumer; establishing a digital payment wallet in the smart meter; establishing an intra-regional electricity transaction on the blockchain based on the electricity supply data and the electricity consumption data, where the electricity transaction includes a plurality of first transaction records about purchasing electricity from the electric energy supplier and a plurality of second transaction records about expenditures when the energy consumer performs electricity accounting, and the first transaction record and the second transaction record are obtained based on accountings by the digital payment wallet; determining an electric energy supply value of the electric energy supplier and an electric energy consumption value of the energy consumer based on the first transaction record and the second transaction record within a region; and calculating an accounting value of intra-regional carbon emission from energy consumption based on the electric energy supply value and the electric energy consumption value within the region.

In an implementation, the establishing of the intra-regional electricity transaction on the blockchain based on the electricity supply data and the electricity consumption data includes:

generating a first traceable code for the electricity supply data and generating a second traceable code for the electricity consumption data; and

uploading the electricity supply data, the first traceable code, the electricity consumption data, and the second traceable code to the blockchain, and establishing the electricity transaction.

In an implementation, the electric energy and carbon emission measurement accounting method based on a digital payment wallet and a blockchain further includes: encrypting the first traceable code and the second traceable code, and uploading the encrypted first traceable code and second traceable code to the blockchain.

In an implementation, the calculating of the accounting value of intra-regional carbon emission from energy consumption based on the electric energy supply value and the electric energy consumption value within the region includes:

subtracting the electric energy consumption value from the electric energy supply value to generate the accounting value of carbon emission from energy consumption of an intra-regional energy network, wherein

if the accounting value of the carbon emission from the energy consumption of the energy network is greater than 0, it indicates that carbon emission from electric energy consumption is positive;

if the accounting value of the carbon emission from the energy consumption of the energy network is equal to 0, it indicates that the carbon emission from the electric energy consumption achieves carbon neutrality; and

if the accounting value of the carbon emission from the energy consumption of the energy network is less than 0, it indicates that the carbon emission from the electric energy consumption is negative.

In an implementation, the digital payment wallet is established based on the blockchain.

In an implementation, performing of the authentication on the digital identity based on the smart contract pre-established by participants includes:

performing authentication on the digital identity in an energy transaction institution and a carbon emission transaction institution according to the pre-established smart contract and a plurality of the participants in combination with basic data information about the smart meter, information about an energy supplier, and information about the energy consumer.

In an implementation, the right confirmation is performed on the digital identity by: performing registration and right confirmation on the digital identity in an energy transaction institution and a carbon emission institution based on digital identity information about each of an operator, the energy supplier, and the energy consumer.

In an implementation, the electric energy and carbon emission measurement accounting method based on a digital payment wallet and a blockchain further includes: performing real-time electricity data accountings and payments between the smart meters through a wireless manner, a wired manner, or a manner of a digital currency chip.

In an implementation, there is one or more smart contracts.

In an implementation, the electric energy and carbon emission measurement accounting method based on a digital payment wallet and a blockchain further includes: performing metering, measurements, analysis, transaction, and accounting on consumed electric energy and the carbon emission from the energy consumption within the region based on the electric energy consumption value and the electric energy supply value.

It may be learned from the foregoing technical solutions that, the present application provides an electric energy and carbon emission measurement accounting method based on a digital payment wallet and a blockchain, including: establishing the digital identities of the intra-regional smart meters based on the blockchain; performing authentication and right confirmation on the digital identity based on the smart contract; performing association of a plurality of the digital identities, on which authentication and right confirmation are performed, with the electric energy suppliers and the energy consumers of the respective ones of the smart meters by the authentication of the digital identity based on the blockchain; identifying the attribute and the data of the smart meter to generate the electricity consumption record data including the electricity supply data of the electric energy supplier and the electricity consumption data of the energy consumer; establishing the digital payment wallet in the smart meter; establishing the intra-regional electricity transaction on the blockchain based on the electricity supply data and the electricity consumption data; determining the electric energy supply value of the electric energy supplier and the electric energy consumption value of the energy consumer based on the first transaction record and the second transaction record within the region; and calculating the accounting value of the intra-regional carbon emission from the energy consumption based on the electric energy supply value and the electric energy consumption value within the region. According to the present application, automatic measurements on power generation capacity and power consumption of a regional power distribution network are performed by the blockchain in combination with the digital payment wallet. In this way, problems about establishment, authentication, and right confirmation of the digital identity of the smart meter are resolved. According to the present application, an accounting value of carbon emission from energy consumption of an intra-regional energy network is generated by subtracting the electric energy consumption value from the intra-regional electric energy supply value, and intra-regional carbon emission is measured based on the accounting value of the carbon emission from the energy consumption of the intra-regional energy network. In this way, the problem that the carbon emission cannot be accurately traced back by an amount of consumed electric energy is resolved, and problems of discredited, unreliable, and inconsistent measurement modes, accounting modes, and values in current measurement accounting processes of the electric energy and the carbon emission from the energy consumption are also resolved.

### BRIEF DESCRIPTION OF THE DRAWINGS

To describe the technical solutions of the present application to more clear, the accompanying drawings to which the embodiments refer are briefly described below. Obviously, persons of ordinary skills in the art may also derive other accompanying drawings according to these accompanying drawings without an effective effort.

FIG. 1 is a schematic flowchart of an electric energy and carbon emission measurement accounting method based on a digital payment wallet and a blockchain according to an embodiment of the present application;

FIG. 2 is a schematic flowchart of a process of generating an accounting value of carbon emission from energy consumption of an intra-regional energy network according to an embodiment of the present application; and

FIG. 3 is a schematic diagram of an electric energy and carbon emission measurement accounting apparatus based on a digital payment wallet and a blockchain according to an embodiment of the present application.

### DETAILED DESCRIPTION OF THE EMBODIMENTS

In order to make objectives, technical solutions, and advantages of the present application more clear, the technical solutions of the present application are described below to be clear and complete with reference to specific embodiments and corresponding accompanying drawings in the present application. Obviously, the described embodiments are merely some, not all, of embodiments of the present application. All other embodiments derived, without creative efforts, by persons of ordinary skills in the art based on the embodiments in the present application fall within the protection scope of the present application. The technical solutions provided in the embodiments of the present application are described in detail below with reference to the accompanying drawings.

Within a range of a region, an amount of consumed electric energy is related to intra-regional carbon emission. In order to acquire the intra-regional carbon emission, measurements on the amount of the consumed electric energy for the region needs to be done. In an implementation, a method for performing measurements on carbon emission may be tracing back the carbon emission by an amount of consumed electric energy. However, in a process of performing measurements on the electric energy, multi supply sources, a plurality of participants, and multi energy consumers may be involved, such as an electric energy supplier and an energy consumer. Different participants may generate different electric energy values, and different energy consumers may use different electric energy. In this way, various types of electric energy values are involved in the process of tracing back the carbon emission by electric energy, and thus a calculation process is very troublesome and easily goes wrong. Therefore, it is impossible to accurately trace back the carbon emission by the amount of the consumed electric energy at present.

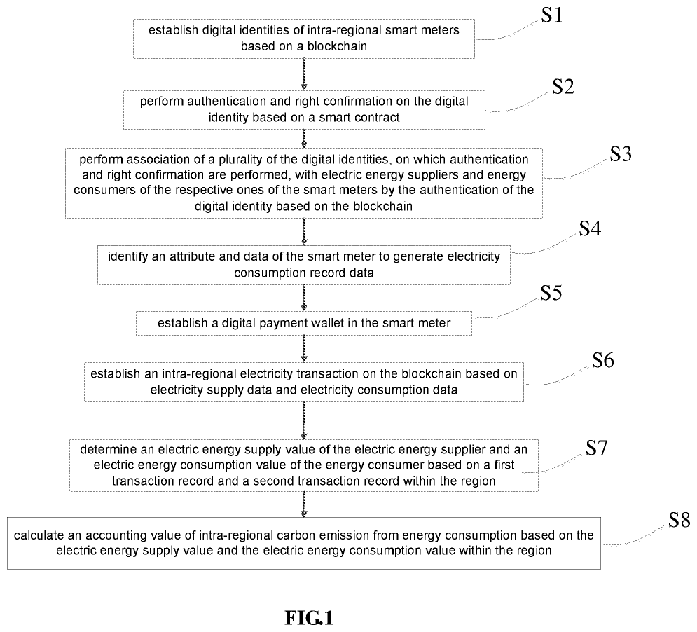

In view of a problem that carbon emission cannot be accurately traced back by an amount of consumed electric energy at present for measurements of electric energy and carbon emission from energy consumption, the present application provides an electric energy and carbon emission measurement accounting method based on a digital payment wallet and a blockchain. FIG. 1 is a schematic flowchart of an electric energy and carbon emission measurement accounting method based on a digital payment wallet and a blockchain according to an embodiment of the present application. As shown in FIG. 1, in this embodiment of the present application, the electric energy and carbon emission measurement accounting method based on a digital payment wallet and a blockchain includes the following steps.

S1: Establish digital identities of intra-regional smart meters based on the blockchain, where each of the smart meters corresponds to one of the digital identities.

In this embodiment of the present application, the digital identity is established according to equipment parameter information and mounting location identification information of the smart meter, an asset party, daily operation information, fault maintenance information, and an electricity transaction party. In this embodiment of the present application, one smart meter corresponds to one digital identity. In this way, information of each smart meter is unique. According to this embodiment of the present application, digital asset authentication and management is performed on the smart meter based on a blockchain technology. The digital identity of the intra-regional smart meter is established based on the equipment parameter information and the mounting location identification information of the smart meter, the asset party, the daily operation information, the fault maintenance information, and the electricity transaction party. Moreover, authentication and right confirmation are performed on the digital identity of the smart meter based on a smart contract established by a participant by the blockchain technology.

After the digital identity of the intra-regional smart meter is established, it may proceed to step S2.

S2: Perform authentication and right confirmation on the digital identity based on a smart contract.

In this embodiment of the present application, the smart contract is a computer protocol aimed at spreading, verifying, or executing a contract by means of information. The smart contract allows trustable transactions without a third party. These transactions are traceable and irreversible, thereby ensuring credibility of data in the smart meter and the transactions. Moreover, in this embodiment of the present application, there may be one or more smart contracts. For example, a unified smart contract may be formulated according to transaction requirements, or several exclusive smart contracts may be customized according to different requirements of a plurality of participants, so that different standards may be formulated for different operations, thereby increasing flexibility and applicability of the transactions. Meanwhile, a supplier may also directly perform an accounting according to a power supply amount based on the smart contract, to obtain an electricity sales payment.

In this embodiment of the present application, the participant is an energy supplier, and may include a thermal power plant, a hydroelectric power plant, a photovoltaic power generating party, a wind power generating party, a nuclear power generating party, an energy storage and discharging party, and the like. The energy consumer may include a daily energy consumer, an energy storage and charging party, a new energy vehicle charging party, and the like. A property-right party may include a property right of a photovoltaic device, a property right of an energy storage device, a property right of a power supply device, and the like. An operator may include a new energy vehicle charging operator, a property owner, a power supply device operator, and the like.

An overall idea of the present application is to: perform digital asset authentication and management on the smart meter by applying the blockchain technology, and perform authentication and right confirmation on the digital identity; perform calculation, measurements, transaction, and accounting on electricity and carbon emission by applying the blockchain technology in combination with the digital payment wallet; and perform automatic accounting on intra-regional electricity consumption and electricity generation based on the smart contract. Meanwhile, based on metering, the measurements, and the accounting of the electricity, metering, measurements, analysis, and transaction accounting of intra-regional carbon emission from energy consumption are implemented, thereby providing a data basis for metering, measurements, analysis, and transaction of the carbon emission.

In specific implementations, first, the immutable digital identity of the smart meter applied to metering, calculation, transaction, and accounting is established based on the blockchain. The digital identity is established by applying the blockchain technology in combination with the equipment parameter information (such as code, characteristics, and a property right of the smart meter) and the mounting location identification information of the smart meter, the asset party, the daily operation information, the fault maintenance information, and the electricity transaction party. After the digital identity is established, authentication and right confirmation are performed on the digital identity based on the smart contract pre-established by the participant, to obtain authentication information of the digital identity confirmed by each participant.

Performing authentication on the digital identity based on the smart contract pre-established by the participants may include the following step of: performing authentication on the digital identity in an energy transaction institution and a carbon emission transaction institution according to the pre-established smart contract and a plurality of the participants in combination with basic data information about the smart meter, information about the energy supplier, and information about the energy consumer, so as to ensure authenticity of data in the smart meter.

For example, in the authentication process, authentication may be performed on the digital identity, based on the smart contract pre-established by the participant, in the energy transaction institution and the carbon emission transaction institution by applying an immutable character of the blockchain technology in combination with the basic data information about the smart meter, the information about the energy supplier, and the information about the energy consumer. A purpose of performing authentication on the digital identity of the smart meter is that authenticity and validity of relevant data in the smart meter may be approved by a transaction participant upon authentication of the digital identity, which is a basic guarantee for transactions.

In some embodiments, right confirmation is performed on the digital identity according to the following manner: performing registration and right confirmation on the digital identity in the energy transaction institution and the carbon emission institution based on digital identity information about the operator, the energy supplier, and the energy consumer. The right confirmation of the smart meter is basis for carbon emission and carbon saving, and is also basis for carbon transactions.

After authentication and right confirmation are performed on the digital identity of the smart meter, it may proceed to step S3.

S3: Perform association of a plurality of the digital identities, on which authentication and right confirmation are performed, with electric energy suppliers and energy consumers of the respective ones of the smart meters by the authentication of the digital identity based on the blockchain, to authenticate all information of the smart meter. In specific implementations, the blockchain technology may be applied to associate a digital identity of a smart meter device on which authentication and right confirmation have been performed with the electric energy supplier and the energy consumer. In this way, in subsequent operations, transactions, accountings, and payments may be directly performed through associated relevant information.

After the association of the authentication information of the digital identity is performed based on the blockchain, it may proceed to step S4.

S4: Identify an attribute and data of the smart meter to generate electricity consumption record data including including electricity supply data of the electric energy supplier and electricity consumption data of the energy consumer. A purpose of identifying the attribute and the data of the smart meter is that each type of electricity consumption corresponds to a different score, and carbon transactions may be performed based on this score. In the identification process, certain principles may be followed. For example, if a power generation mode is relatively carbon saving and power generation may gain a bonus point according to principles of energy conservation, a corresponding value of an amount of the corresponding power generation mode in the smart meter is positive. On the contrary, if the power generation mode generates corresponding carbon emission and the power generation may lose points according to the principles of energy conservation, a corresponding value of an amount of the corresponding power generation mode in the smart meter is a negative. Finally, carbon transactions may be performed according to the score in the smart meter.

For example, a power grid accounting is taken as an example for the smart meter, where a corresponding value of an amount of thermal power supplied by a power grid to an electricity consumer may be recorded as a negative value in the smart meter. A corresponding value of an amount of green power (photovoltaic power generation, nuclear power, hydropower, or wind power) supplied by the power grid to the electricity consumer may be recorded as a positive value in the smart meter. A corresponding value of an amount of grid-connected photovoltaic power generation in the smart meter may be recorded as a positive value. These data are all automatically metered and generated during an access process of an electricity consumption system.

After the attribute and the data of the smart meter are identified to generate the electricity consumption record data, it may proceed to step S5.

S5: Establish a digital payment wallet in the smart meter by applying a blockchain technology. In this way, by establishing the smart contract among a plurality of suppliers, each participant may perform automatic metering, calculation, measurements, and accounting on supplied electricity based on the smart contract. In an implementation, real-time electricity data accountings and payments are performed between the smart meters through a wireless manner, a wired manner, or a manner of a digital currency chip. Moreover, payment transactions about electricity supply and demand and carbon emission transactions are performed by using the digital payment wallet in the smart meter.

After the digital payment wallet is established in the smart meter, it may proceed to step S6.

S6: Establish an intra-regional electricity transaction on the blockchain based on the electricity supply data and the electricity consumption data. The electricity transaction includes a plurality of first transaction records about purchasing electricity from the electric energy supplier and a plurality of second transaction records about expenditures when the energy consumer performs electricity accounting. The first transaction record and the second transaction record are obtained based on accountings by the digital payment wallet.

In specific implementations, since the digital payment wallet has been established in the smart meter, all transactions through the smart meter are settled by using the digital payment wallet. To further distinguish between the power supply amount and the electricity consumption amount for the region, in this embodiment of the present application, a transaction record formed in a transaction of purchasing electricity from the electric energy supplier is recorded as a first transaction record, and a transaction record formed in a transaction of paying for consumed electricity by the energy consumer is recorded as a second transaction record. It is easy to understand that there may be a plurality of first transaction records and a plurality of second transaction records, and the first transaction records and the second transaction records are obtained based on the accountings by the digital payment wallet. For example, in an actual application scenario, electricity may be purchased or paid by phases, and a plurality of first transaction records and a plurality of second transaction records may be generated.

In an implementation, the intra-regional electricity transaction may be established on the blockchain based on the electricity supply data and the electricity consumption data according to the following steps: generating a first traceable code for the electricity supply data and generating a second traceable code for the electricity consumption data, based on the blockchain; and uploading the electricity supply data, the first traceable code, the electricity consumption data, and the second traceable code to the blockchain, and establishing the electricity transaction.

In the foregoing steps, after the authentication information of the digital identity is associated based on the blockchain, the attribute and the data of the smart meter are identified to generate the electricity consumption record data. The electricity consumption record data includes the electricity supply data of the electric energy supplier and the electricity consumption data of the energy consumer. In other words, in this embodiment of the present application, the electricity supply data and the electricity consumption data not only include “values” themselves of supplied electricity and consumed electricity, but also include all data associated with electricity supply and electricity consumption. For example, at least an electric energy supply source, a supplier, the energy consumer, the attribute of the smart meter, an electricity supply value, and an electricity consumption value are included. These values are closely related to calculation of a final electricity value, and are data bases for calculating electricity, electric energy, and carbon emission.

For the foregoing reasons, in this embodiment of the present application, the first traceable code is generated from all relevant data in the electricity supply data based on the blockchain. The first traceable code is unique, credible, and immutable identification code generated for all associated data in the electricity supply data. All data related to electricity supply may be queried and traced through the first traceable code. Process data cannot be modified manually, thereby ensuring reliability of the electricity supply data. Similarly, the second traceable code is generated for the electricity consumption data based on the blockchain. The second traceable code is unique, credible, and immutable identification code generated for all associated data in the electricity consumption data. All data related to electricity consumption may be queried and traced through the second traceable code. Process data cannot be modified manually, thereby ensuring reliability of the electricity consumption data. On the basis of ensuring the reliability of the electricity supply data and the electricity consumption data, reliability and authenticity of final electric energy data and carbon emission data may be ensured.

To further ensure reliability of basic electricity data such as the supply source, the power supply amount, and the electricity consumption amount, this embodiment of the present application further includes encrypting the first traceable code and the second traceable code, and uploading the encrypted first traceable code and second traceable code to the blockchain. In this way, security of the basic electricity data is further ensured. All the electricity supply data and the electricity consumption data cannot be acquired without an encryption password, which may be set according to an actual situation. For example, the password may be known by only an administrator in responsible of measurements for the region, or be known by several persons, which is not limited in the present application.

After the electricity transaction is established, it may proceed to step S7.

S7: Determine an electric energy supply value of the electric energy supplier and an electric energy consumption value of the energy consumer based on a first transaction record and a second transaction record within the region. Because the first transaction record is a record related to electricity purchase, and the second transaction record is a record related to the expenditure of electricity consumption, the electric energy supply value and the electric energy consumption value may be calculated according to a preset algorithm based on the generated first transaction record and second transaction record. The preset algorithm may be defined according to actual demand and power consumption for the region. This is not limited in the present application.

In some embodiments, the authentication is performed on the digital identity of the smart meter by applying the blockchain and the smart contract in the present application. A “smart meter for metering photovoltaic power generation” may be taken as a metering point of a green energy power generation capacity. A “metering point of power supply of a power grid and grid-connected power generation” may be taken as nodes of metering, measurements, analysis, accounting, and payment of regional energy supply. The digital payment wallet may be used to conduct accounting on the power supply amount and the electricity consumption amount within the region. The digital payment wallet is effectively in combination with the blockchain, so that electricity transactions and regional carbon emission transactions are performed between the smart meters through a wired manner, a wireless manner, or a manner of a digital currency chip card by using the digital payment wallet in the smart meter based on electricity metered by the smart meter and the smart contract.

After the electric energy supply value of the electric energy supplier and the electric energy consumption value of the energy consumer are calculated, it may proceed to step S8.

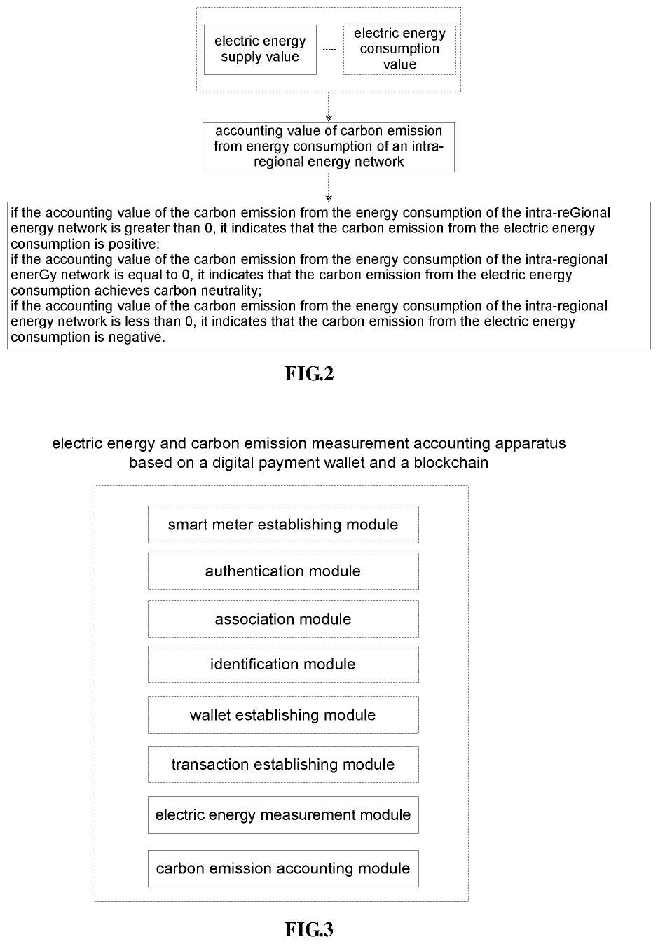

S8: Calculate an accounting value of intra-regional carbon emission from energy consumption based on the electric energy supply value and the electric energy consumption value within the region. FIG. 2 is a schematic flowchart of a process of generating an accounting value of carbon emission from energy consumption of an intra-regional energy network according to an embodiment of the present application. As shown in FIG. 2, the accounting value of the carbon emission from the energy consumption of the intra-regional energy network may be generated by subtracting the electric energy consumption value from the electric energy supply value. In some embodiments, metering, measurements, analysis, transaction, and accounting may be performed on consumed electric energy and carbon emission from energy consumption within the region based on the electric energy consumption value and the electric energy supply value. Measurements on use of carbon emission from electric energy consumption within the region are performed according to a preset principle. If the accounting value of the carbon emission from the energy consumption of the energy network is greater than 0, it indicates that the carbon emission from the electric energy consumption is positive. If the accounting value of the carbon emission from the energy consumption of the energy network is equal to 0, it indicates that the carbon emission from the electric energy consumption achieves carbon neutrality. If the accounting value of the carbon emission from the energy consumption of the energy network is less than 0, it indicates that the carbon emission from the electric energy consumption is negative.

In specific implementations, for example, if a value obtained by subtracting the electric energy consumption value from the electric energy supply value of self-supplied electricity for the region is 0 (for example, an amount of a grid-connected power generation is “0”, and a power supply amount of the power grid is “0”), it indicates that electric energy for the region is self-sufficient, and regional carbon emission from electricity consumption is “0”. In this way, the electricity consumption for the region achieves carbon neutralization. If a value obtained by subtracting an electric energy consumption value of the grid-connected power generation from an electric energy supply value of a regional power grid is a positive number (for example, the electric energy supply value of the power grid is greater than a value of the grid-connected power generation), it indicates that the amount of the intra-regional grid-connected power generation is lesser than the electricity consumption amount. In this case, intra-regional carbon emission of the electric energy is “+”, and expenses on the carbon emission need to be paid. If the value obtained by subtracting the electric energy consumption value of the grid-connected power generation from the electric energy supply value of the regional power grid is a negative number (for example, the electric energy supply value of the power grid is less than the value of the grid-connected power generation), it indicates that the amount of the intra-regional grid-connected power generation is greater than the electricity consumption amount, carbon emission of the electric energy is “−”, and the carbon emission is negative. In this case, saved carbon for the region by energy conservation and consumption reduction may be sold to gain profits.

In an implementation, this embodiment of the present application further includes: performing accountings and payments on the carbon emission from energy consumption by using the digital payment wallet based on the electricity supply data, the electricity consumption data, and the smart contract, to generate a carbon emission value of supplied electric energy and a carbon emission value of consumed electric energy. According to this embodiment of the present application, metering, measurements, analysis, and accounting are performed on electricity supply, electricity consumption, and carbon emission from electric energy consumption for the region through a technology of the blockchain in combination with the digital payment wallet. This provides a reliable and immutable data base for measurement, measurements, analysis, transaction, and accounting on carbon emission from electric energy consumption of distributed photovoltaic, distributed energy storage, new energy vehicles, and daily electricity consumption.

In an actual application scenario, the regional power distribution network may be composed of a plurality of parties. For example, in some embodiments, the regional power distribution network may be composed of power supply of the power grid, residential electricity consumption, and a new energy vehicle. In some other embodiments, the regional power distribution network may be composed of power supply of the power grid, residential electricity consumption, a new energy vehicle, and an energy storage device. In yet some embodiments, the regional power distribution network may also be composed of power supply of the power grid, residential electricity consumption, a new energy vehicle, and a photovoltaic power generation. It should be noted that, no matter which of the foregoing composition modes is adopted for the regional power distribution network, the intra-regional smart meter may perform real-time electricity data delivery and accounting data delivery through a wireless manner, a wired manner, or a manner of a digital currency chip card; and perform payment about electricity supply and demand and carbon emission transactions by using the digital payment wallet in the smart meter.

It may be learned from the foregoing technical solutions that, the present application provides an electric energy and carbon emission measurement accounting method based on a digital payment wallet and a blockchain, including: establishing the digital identities of the intra-regional smart meters based on the blockchain; performing authentication and right confirmation on the digital identity based on the smart contract; performing association of a plurality of the digital identities, on which authentication and right confirmation are performed, with the electric energy suppliers and the energy consumers of the respective ones of the smart meters by the authentication of the digital identity based on the blockchain; identifying the attribute and the data of the smart meter to generate the electricity consumption record data including the electricity supply data of the electric energy supplier and the electricity consumption data of the energy consumer; establishing the digital payment wallet in the smart meter; establishing the intra-regional electricity transaction on the blockchain based on the electricity supply data and the electricity consumption data; determining the electric energy supply value of the electric energy supplier and the electric energy consumption value of the energy consumer based on the first transaction record and the second transaction record within the region; and calculating the accounting value of the intra-regional carbon emission from the energy consumption based on the electric energy supply value and the electric energy consumption value within the region. According to the present application, automatic measurements on the power generation capacity (electricity supply data) and the power consumption (electricity consumption data) of the regional power distribution network are performed by the blockchain in combination with the digital payment wallet. In this way, problems about establishment, authentication, and right confirmation of the digital identity of the smart meter are resolved. According to the present application, an accounting value of carbon emission from energy consumption of an intra-regional energy network is generated by subtracting the electric energy consumption value from the intra-regional electric energy supply value, and the intra-regional carbon emission is measured based on the accounting value of the carbon emission from the energy consumption of the intra-regional energy network. In this way, the problem that the carbon emission cannot be accurately traced back by the amount of the consumed electric energy is resolved, and problems of discredited, unreliable, and inconsistent measurement modes, accounting modes, and values in current measurement accounting processes of the electric energy and the carbon emission from the energy consumption are also resolved.

In addition, on the basis of the foregoing electric energy and carbon emission measurement accounting method based on a digital payment wallet and a blockchain, the present application further includes an electric energy and carbon emission measurement accounting apparatus based on a digital payment wallet and a blockchain. FIG. 3 is a schematic diagram of an electric energy and carbon emission measurement accounting apparatus based on a digital payment wallet and a blockchain according to an embodiment of the present application. As shown in FIG. 3, the electric energy and carbon emission measurement accounting apparatus based on a digital payment wallet and a blockchain includes:

a smart meter establishing module, where the smart meter establishing module establishes digital identities of intra-regional smart meters based on the blockchain, and each of the smart meters corresponds to one of the digital identities;

an authentication module, where the authentication module performs authentication and right confirmation on the digital identity based on a smart contract;

an association module, where the association module associates, a plurality of the digital identities, on which authentication and right confirmation are performed, with electric energy suppliers and energy consumers of the respective ones of the smart meters by the authentication of the digital identity based on the blockchain;

an identification module, where the identification module identifies an attribute and data of the smart meter to generate electricity consumption record data including electricity supply data of the electric energy supplier and electricity consumption data of the energy consumer;

a wallet establishing module, where the wallet establishing module establishes a digital payment wallet in the smart meter;

a transaction establishing module, where the transaction establishing module establishes an intra-regional electricity transaction on the blockchain based on the electricity supply data and the electricity consumption data, the electricity transaction includes a plurality of first transaction records about purchasing electricity from the electric energy supplier and a plurality of second transaction records about expenditures when the energy consumer performs electricity accounting, and the first transaction record and the second transaction record are obtained based on accountings by the digital payment wallet;

an electric energy measurement module, where the electric energy measurement module determines an electric energy supply value of the electric energy supplier and an electric energy consumption value of the energy consumer based on the first transaction record and the second transaction record within the region; and

a carbon emission accounting module, where the carbon emission accounting module calculates an accounting value of intra-regional carbon emission from energy consumption based on the electric energy supply value and the electric energy consumption value within the region.

A person skilled in the art would easily conceive of other implementation solutions of the present application after considering the specification and practicing the application disclosed herein. The present application is intended to cover any variation, use, or adaptive change of the present application. These variations, uses, or adaptive changes follow the general principle of the present application and include the common general knowledge or common technical means in this technical filed that is not disclosed in the present application. The specification and the embodiments are merely considered to be exemplary, and the actual scope and spirit of the present application are indicated in the following claims.

It should be understood that the present application is not limited to the exact structure that is described above and is shown in the figures, and various modifications and changes may be made thereto, without departing from the scope thereof. The scope of the present application is merely limited by the appended claims.

What is claimed is:

1. An electric energy and carbon emission measurement accounting method based on a digital payment wallet and a blockchain, comprising:
establishing digital identities of intra-regional smart meters based on the blockchain, wherein each of the smart meters corresponds to one of the digital identities;
performing authentication and right confirmation on the digital identity based on a smart contract;
performing association of a plurality of the digital identities, on which authentication and right confirmation are performed, with electric energy suppliers and energy consumers of the respective ones of the smart meters by the authentication of the digital identity based on the blockchain;
identifying an attribute and data of the smart meter to generate electricity consumption record data comprising electricity supply data of the electric energy supplier and electricity consumption data of the energy consumer;
establishing a digital payment wallet in the smart meter;
establishing an intra-regional electricity transaction on the blockchain based on the electricity supply data and the electricity consumption data, wherein the electricity transaction comprises a plurality of first transaction records about purchasing electricity from the electric energy supplier and a plurality of second transaction records about expenditures when the energy consumer performs electricity accounting, and the first transaction record and the second transaction record are obtained based on accountings by the digital payment wallet;
determining an electric energy supply value of the electric energy supplier and an electric energy consumption value of the energy consumer based on the first transaction record and the second transaction record within a region; and
calculating an accounting value of intra-regional carbon emission from energy consumption based on the electric energy supply value and the electric energy consumption value within the region.

2. The electric energy and carbon emission measurement accounting method based on a digital payment wallet and a blockchain according to claim 1, wherein the establishing of the intra-regional electricity transaction on the blockchain based on the electricity supply data and the electricity consumption data comprises:
generating a first traceable code for the electricity supply data and generating a second traceable code for the electricity consumption data, based on the blockchain; and
uploading the electricity supply data, the first traceable code, the electricity consumption data, and the second traceable code to the blockchain, and establishing the electricity transaction.

3. The electric energy and carbon emission measurement accounting method based on a digital payment wallet and a blockchain according to claim 2, further comprising: encrypting the first traceable code and the second traceable code, and uploading the encrypted first traceable code and second traceable code to the blockchain.

4. The electric energy and carbon emission measurement accounting method based on a digital payment wallet and a blockchain according to claim 1, wherein the calculating of the accounting value of intra-regional carbon emission from energy consumption based on the electric energy supply value and the electric energy consumption value within the region comprises:
subtracting the electric energy consumption value from the electric energy supply value to generate the accounting value of carbon emission from energy consumption of an intra-regional energy network, wherein
if the accounting value of the carbon emission from the energy consumption of the energy network is greater than 0, it indicates that carbon emission from electric energy consumption is positive;
if the accounting value of the carbon emission from the energy consumption of the energy network is equal to 0, it indicates that the carbon emission from the electric energy consumption achieves carbon neutrality; and
if the accounting value of the carbon emission from the energy consumption of the energy network is less than 0, it indicates that the carbon emission from the electric energy consumption is negative.

5. The electric energy and carbon emission measurement accounting method based on a digital payment wallet and a blockchain according to claim 1, wherein the digital payment wallet is established based on the blockchain.

6. The electric energy and carbon emission measurement accounting method based on a digital payment wallet and a blockchain according to claim 1, wherein performing of the authentication on the digital identity based on the smart contract pre-established by participants comprises:
performing authentication on the digital identity in an energy transaction institution and a carbon emission transaction institution according to the pre-established smart contract and a plurality of the participants in combination with basic data information about the smart meter, information about an energy supplier, and information about the energy consumer.

7. The electric energy and carbon emission measurement accounting method based on a digital payment wallet and a blockchain according to claim 1, wherein the right confirmation is performed on the digital identity by: performing registration and right confirmation on the digital identity in an energy transaction institution and a carbon emission institution based on digital identity information about each of an operator, the energy supplier, and the energy consumer.

8. The electric energy and carbon emission measurement accounting method based on a digital payment wallet and a blockchain according to claim 1, further comprising: performing real-time electricity data accountings and payments between the smart meters through a wireless manner, a wired manner, or a manner of a digital currency chip.

9. The electric energy and carbon emission measurement accounting method based on a digital payment wallet and a blockchain according to claim 1, wherein there is one or more smart contracts.

10. The electric energy and carbon emission measurement accounting method based on a digital payment wallet and a blockchain according to claim 1, further comprising: performing metering, measurements, analysis, transaction, and accounting on consumed electric energy and the carbon emission from the energy consumption within the region based on the electric energy consumption value and the electric energy supply value.
